(19) United States
(12) Patent Application Publication
(10) Pub. No.: US 2018/0088530 A1
(43) Pub. Date: Mar. 29, 2018

(54) Geometries for Hairsprings for Mechanical Watches Enabled By Nanofabrication

(71) Applicant: Firehouse Horology Inc., New York, NY (US)

(72) Inventors: Kiran Shekar, New York, NY (US); Nicholas Manousos, Brooklyn, NY (US); Milan Begliarbekov, New York, NY (US)

(73) Assignee: Firehouse Horology Inc., New York, NY (US)

(21) Appl. No.: 15/819,317

(22) Filed: Nov. 21, 2017

Related U.S. Application Data
(63) Continuation-in-part of application No. 15/365,091, filed on Nov. 30, 2016.

(51) Int. Cl. G04B 17/06

(52) U.S. Cl. CPC G04B 17/066

(57) ABSTRACT

In this patent we teach a method for manufacturing hairsprings for mechanical watches using nanofabrication and several resultant geometries. This method produces hairsprings, and other watch components, that are more durable, more precise, more isochronous, possess a different appearance, and are easier to install into a watch. For example, we discuss novel geometries of hairspring coils with non-rectangular cross-sections, hairsprings with attached or integrated collets, detachable collets, notched collets, tabs, and small identifying features. Furthermore, we teach how the cross-section of a hairspring may be modified in order to alter the spring's geometric moment thereby improving isochronism.

### PRIORITY CLAIM

This application claims priority under 35 U.S.C. 120 to U.S. application Ser. No. 15/365,091 filed on Nov. 30, 2016, the content of which is relied upon and incorporated herein in its entirety.

### FIELD OF INVENTION

The present invention relates to the field of mechanical timepieces. In particular, this invention teaches manufacturing hairsprings with novel geometries which are made possible using nanofabrication techniques such as electron beam and optical lithography, reactive ion etching, and deposition techniques such as sputtering, electron beam deposition, plasma enhanced chemical vapor deposition (PECVD), atomic layer deposition, and thermal oxidation to create hairsprings that are more durable, more precise, more isochronous, possess a different appearance, and/or are easier to install into a mechanical timepiece.

In addition, this invention teaches manufacturing watch parts other than hairsprings with novel geometries which are made possible using nanofabrication techniques.

In addition, this invention teaches fabricating mechanical watch components, including hairsprings, from a new class of materials, namely crystalline compounds and laminated crystalline compounds.

### BACKGROUND OF THE INVENTION

The manufacturing process that is used to fashion metal alloy hairsprings consists of an extrusion of the alloy to form the desired dimensions of the hairspring and then a mechanical coiling process followed by an annealing process. The processes of extruding and mechanically coiling the hairspring limits the possible geometries of the hairspring.

In this patent we teach a new method of producing hairsprings using nanofabrication techniques which enables the fabrication of springs with novel geometries which were heretofore impractical to fabricate using conventional methods. For example, non-two-dimensional designs such as non-rectangular cross sections, attached collets, tabs, notched collets and fine identifying features are not possible using conventional techniques for creating metal hairsprings.

In this patent we teach several geometries, and classes of geometries, for hairsprings enabled by nanofabrication.

Utilizing nanofabrication in the manufacturing of hairsprings and other components of mechanical timepieces enables heretofore unprecedented control of the manufacturing process. Components manufactured using nanofabrication processes can be repeatedly and reliably made to tolerances smaller than 10 nanometers with variances below one percent. These advantages enable the design and manufacture of components for mechanical timepieces, specifically hairsprings, that are impractical to achieve by any other method. More specifically, novel geometries that can now be realized using nanofabrication techniques result in much more precise hairsprings that are more isochronous and are also less sensitive to changes in their environment which would otherwise adversely affect the quality of a mechanical timepiece. Furthermore, since nanofabrication is inherently a parallel process (that is, a plurality of components can be manufactured simultaneously on a single wafer), this technique is ideal for high throughput manufacturing.

The unprecedented level of precision to which the geometric tolerances of hairsprings can be controlled affects the following properties of the resultant hairsprings:
a. Precision, hairsprings manufactured using the methods taught in this patent have a significantly smaller deviation from a nominal oscillating frequency;
b. Isochronism, that is the ability of the hairspring-balance unit to maintain the same frequency of oscillation regardless of the amplitude of oscillation (the amplitude of the oscillation may change depending on the amount of torque that is supplied from the mainspring);
c. Durability, that is the ability of the hairspring to withstand shocks or other forms of mechanical stress that may be encountered when it is being installed into a movement or when the watch which contains the hairspring is worn;
d. Ease of installation and handling by the watchmaker who installs the hairspring into the movement; and/or
e. Appearance, that is nanofabrication techniques can be utilized to alter the appearance of the hairspring or other components of mechanical timepieces for design, identification, or anti-counterfeiting purposes among other reasons.

### DESCRIPTION OF RELATED ART

In US Patent Application 2006/0055097 (entitled “Hairspring for balance hairspring resonator and production method thereof”) Conus, et al. teach a hairspring fabricated from an amorphous or crystalline material. However, Conus, et al. fail to teach fabricating a hairspring from a crystalline compound or doped crystalline compound wherein the hairspring has chamfered edges, the hairspring coils have a non-rectangular cross section, a detachable handle for ease of installation of the hairspring, or collets with novel geometries.

In U.S. Pat. No. 7,077,562 (entitled “Watch hairspring and method for making same”) Bourgeois, et al. teach a hairspring cut from a single-crystal silicon plate. However, Bourgeois, et al. fail to teach fabricating a hairspring from a crystalline compound or doped crystalline compound wherein the hairspring has chamfered edges or non-rectangular cross-sections, a detachable handle for ease of installation or collets with novel geometries.

In U.S. Pat. No. 8,882,341 (entitled “Stress-relief elastic structure of hairspring collet”), Chu, et al. teach using micro-fabrication techniques to make hairsprings with a flexible collet to attach to the balance staff. However, Chu, et al. fail to teach fabricating the hairspring from a crystalline compound, chamfered edges or a non-rectangular cross section for the hairspring coils, or collets with novel geometries.

In U.S. Pat. No. 3,364,673 (entitled “Horologe hairspring attachment collet”), Boult teaches modifying the wall thickness of a collet for a hairspring for ease of attachment to a balance staff. However, Boult fails to teach using microfabrication techniques to manufacture the hairspring, fabricating the hairspring from a crystalline compound, a non-rectangular cross section for the hairspring coils, or collets with novel geometries.

In US Patent Application 2015/0023140 (entitled “Integral assembly of a hairspring and a collet”) Daout, et al. teach micromachining a hairspring and collet wherein the collet is elastic, has a closed contour, and is non-circular. However, Daout, et al. fail to teach fabricating the hairspring and collet from a crystalline compound, chamfered edges on the hairspring, the hairspring coils have a non-rectangular cross section, a detachable handle for ease of installation of the hairspring, or collets with novel geometries.

In U.S. Pat. No. 7,213,966 (entitled “Collet without deformation of the fixation radius of the balance-spring and manufacturing method of the same”) Lambert, et al. teach a collet for mounting a balance staff with a non-circular inner contour for contacting with the balance staff. However, Lambert, et al. teach fabricating the hairspring from steel and fail to teach fabricating the hairspring and collet for mounting a balance staff out of a crystalline compound or collets with novel geometries.

In U.S. Pat. No. 8,393,783 (entitled “Hairspring for a balance wheel/hairspring resonator”) Daout, et al. teach a balance wheel with a hairspring having a collet and at least two blades wound around the collet. However, Daout, et al. fail to teach fabricating a hairspring from a crystalline compound or laminated crystalline compound wherein the hairspring coils have chamfered edges or non-rectangular cross sections, a detachable handle for ease of installation, or collets with novel geometries.

In European Patent Application EP 2687917 (entitled “Hairspring for a timepiece and hairspring design for concentricity”) Ching teaches using microfabrication techniques to fabricate a hairspring of varying stiffness throughout the coils. However, Ching fails to teach fabricating a hairspring from a crystalline compound or laminated crystalline compound wherein the hairspring has chamfered edges or non-rectangular cross sections, a detachable handle for ease of installation of the hairspring, or collets with novel geometries.

In U.S. Pat. No. 8,296,953 (entitled “Method of manufacturing a one-piece hairspring”) Bühler, et al. teach a hairspring with a raised terminal curve. However, Bühler, et al. fail to teach fabricating a hairspring from a crystalline compound or laminated crystalline compound wherein the hairspring has chamfered edges or non-rectangular cross-sections, a detachable handle for ease of installation, or collets with novel geometries.

In U.S. Pat. No. 8,425,110 (entitled “Breguet overcoil balance spring made of silicon-based material”) Zaugg, et al. teach a Breguet overcoil balance spring wherein an elevation device is disposed between an outer coil of the hairspring and the terminal curve. However, Zaugg, et al. fail to teach fabricating a hairspring from a crystalline compound or laminated crystalline compound wherein the hairspring has chamfered edges or non-rectangular cross-sections, a detachable handle for ease of installation, or collets with novel geometries.

### BRIEF DESCRIPTION OF THE INVENTION

Silicon hairsprings are manufactured using a variety of nanofabrication processes. The process can be broken down into three principal steps—lithography, etching, and deposition. In the lithography step a pattern is transferred to the substrate, for example through the use of an ultraviolet light-sensitive photoresist. In the etching step the previously transferred pattern serves as a mask, and any exposed material is etched away using either a dry (plasma) process or wet (chemical) process. In the deposition step a laminate material is created by applying one or more layers of coating to the previously etched substrate. The additional coatings can be applied to alter the appearance of the hairspring such as for identification purposes.

Crystalline compounds and doped silicon are described in detail in U.S. application Ser. No. 15/365,091 filed on Nov. 30, 2016, the content of which is relied upon and incorporated herein in its entirety. Crystalline compounds are defined as a crystalline solid where the unit cell is made of more than one type of atom.

Novel geometries, as described herein, can improve the properties of watch parts, such as hairsprings, in five principal areas: precision, isochronism, durability, ease of installation, and/or modifying appearance.

The history of mechanical watchmaking has been a steady march of increased precision. That work has involved changing the way parts are made, as well as changing the parts themselves to geometries that inherently improve precision. Nanofabrication techniques, as outlined herein, allow different geometries heretofore unachievable using traditional watchmaking techniques, to further improve that precision.

Isochronism has to do with the ability of the hairspring-balance assembly to maintain the same frequency of oscillation regardless of the amplitude (the amplitude of the oscillation may change depending on the amount of torque that is supplied to the hairspring from the mainspring). Ideally a hairspring-balance assembly will oscillate at the same rate regardless of the state of wind of the mainspring, but in practice this usually isn't the case. However, nanofabrication enables geometries which are more isochronous.

Durability is important for mechanical watch components. It is important to be able to withstand the various forms of contact, stress, vibrations, and other perturbations that the watch may be subjected to in the course of normal installation and use. Through the use of geometries, as mentioned herein, that durability can be improved.

Installing watch components is difficult because it is time consuming and during the installation process hairsprings are frequently broken or damaged. However using some of the hairspring geometries outlined herein can speed up installation and/or service. In addition these hairspring geometries can prevent damage to parts during the installation and/or servicing.

Modifying appearance of the mechanical timepiece is useful as mechanical timepieces are often prized for the appearance of their mechanisms (referred to as ‘movements’ in watchmaking parlance). Traditional watch manufacturing involves using a variety of treatments to modify the appearance of the movement. Using nanofabrication, a range of new options are available for modifying the appearance of watch parts which gives additional options for designers to create the aesthetic look they desire.

### BRIEF DESCRIPTION OF THE DRAWINGS

FIG. 1 shows a typical process flow for nanofabrication of a wafer.

FIG. 2A shows a photograph of hairsprings fabricated in the manner described above (the hairsprings are still attached to the wafer).

FIG. 2B shows a photograph of a hairspring-balance assembly to be installed into the movement of a watch.

FIG. 3 shows a hairspring completely installed into a movement of a watch.

FIG. 4 shows a top view of a hairspring with a protrusion/handle on both the inner and outer curves.

FIG. 5A shows a top view of a hairspring with a detachable collet on the inner terminus of the hairspring.

FIG. 5B shows Detail A of a detachable collet on the inner terminus of the hairspring.

FIG. 6A shows a top perspective view of hairspring with a collet that is both notched and jagged.

FIG. 6B shows a top view of the notched and jagged collet as seen in FIG. 6A.

FIG. 6C shows Detail A of a notched and jagged collet as seen in FIG. 6A and FIG. 6B.

FIG. 7 shows a top perspective view of a hairspring with a notched and jagged collet and an adhesive applied on the jagged inner surface in order to attach the collet to the balance staff.

FIG. 8A shows a rectangular cross-section of a hairspring.

FIG. 8B shows a rectangular cross-section of a hairspring with the top two edges beveled.

FIG. 8C shows a rectangular cross-section of a hairspring with four beveled edges.

FIG. 8D shows a cross-section of a hairspring with a rounded edge on one side.

FIG. 9A shows a top view of a hairspring with a detachable handle on the outer terminus.

FIG. 9B shows a detailed view of the detachment point for the detachable handle on the outer terminus from FIG. 9A.

FIG. 9C shows a top view of a hairspring with a handle and an attachment tab.

FIG. 9D shows a detailed view of the handle with attachment tab from FIG. 9C.

FIG. 10 shows a top view of a hairspring in which the outermost coils have been elongated in one dimension of the hairspring.

FIG. 11 shows a top view of a hairspring geometry in which the width of the hairspring is varied along the curve.

FIG. 12 shows a top view of a hairspring with an eccentric outermost coil.

FIG. 13 shows a top view of a hairspring with text printed on the coils.

FIG. 14 shows a gear for a mechanical timepiece with text and a graphic applied to it for the purposes of identification or decoration.

### DETAILED DESCRIPTION OF THE INVENTION

The following is a non-limiting written description of embodiments illustrating various aspects of this invention. As used herein, the terms mechanical watch and mechanical timepiece are deemed to be synonymous. As used herein, the terms chamfer and bevel are deemed to be synonymous.

The hairspring of a mechanical watch has three basic parts: coils, an inner terminus, and an outer terminus. The inner terminus provides a secure connection of the hairspring to the balance staff, so that it moves when the balance staff does, and not otherwise. The coils, along with the balance wheel, determine the frequency of oscillation of the watch by their geometrical parameters such as height, width, numbers of coils, and length, and their material parameters such as elasticity as density. The outer terminus is used to securely connect the hairspring to the stud, which provides a fixed end for the oscillation, and enables some fine timing regulation.

In addition to the previously mentioned three basic parts of a hairspring, other parts can be added such that they do not interfere with the oscillation of the hairspring. These include, but are not limited to handles and tabs.

The process of installing and adjusting a hairspring is one of the most delicate and difficult parts of watchmaking. As such, any improvement to that process is beneficial. Two possible improvements discussed here are the addition of handles at either the inner or the outer ends of the hairspring.

Adding a handle at the inner terminus simplifies the installation of the hairspring into the watch movement. Part of what makes installing and adjusting a hairspring so difficult is that there aren't many places the hairspring can be grasped using tweezers, or similar instruments, without risk of damage to the hairspring. The inner terminus and outer terminus are the usually places the hairspring is grasped, because the coils are the most delicate part. However, the geometries of inner and outer terminuses and generally not optimized for grasping, and thus the addition of added components, such as a handle, protruding from the inner terminus such that a user can manipulate and adjust the hairspring during installation without touching the coils would much reduce the probability of breakage or damage.

Similarly, the addition of a handle at the outer terminus can also be utilized to simplify the handling of the hairspring. The choice of the location of the handle location, either at the inner or the outer termini, or both termini, depends on the specific geometry of the movement into which the hairspring will be installed.

An additional geometric improvement afforded by nanofabrication is the addition of an integrated collet. A collet attaches the hairspring to the balance staff. An integrated collet allows the innermost coils of the hairspring to be positioned closer to the axis of rotation, which improves isochronism. The shape of the collet can be designed to ensure that the fit is rigid so that the collet does not slip, and thus affect the oscillations of the hairspring.

The collet can also be detachable. If the collet can be detached from the hairspring, it is referred to as a spring clip. Traditional hairspring manufacturing techniques utilize collets and spring clips; however, they are typically made from a separate piece of metal which is subsequently bonded to the hairspring. However, the bonding process is often imprecise and limits the geometries of the collet and spring clip. Here we teach that nanofabrication can be used to fashion the spring clip or collet from the same wafer the hairspring is fashioned. This monolithic construction affords greater precision, and facilitates the fabrication of lighter parts which are advantageous in watchmaking.

Another geometric complication that is easily facilitated by nanofabrication is the inclusion of a notched collet. The notched collet is fabricated in the same manner described above: the hairspring, collet, and the notch in the collet are formed during the same etch step, and are all integral to the hairspring. The notched collet can be integrated with or detachable from the hairspring. Having a notch or opening in the collet allows the collet to be placed on a staff that is slightly larger in diameter than the collet size, then tension can be utilized in a slightly stretched collet to create a more secure friction fit.

Furthermore, the collet can be attached to the balance staff using an adhesive. In a preferred embodiment, glue is used to adhere the hairspring to the balance staff, but other types of adhesives that do not deform the integrity of the notch or hairspring are conceived. Another geometric complication that is easily facilitated by nanofabrication is the use of a jagged collet, where the inner surface of the collet may be jagged so there is a larger surface area for the adhesive to adhere to the balance staff. This creates a much more secure fit. This invention conceives of multiple preferred embodiments that include permutations of integrated or detachable collets, notched or unnotched collets and jagged or not jagged collets.

In addition the techniques described above can be used to form a detachable handle at the outer terminus of the spring. This allows the use of a handle that is ideal for installation purposes, even if the appearance is unattractive, since the handle can simply be removed after the hairspring has been full installed and adjusted.

The detachment process is facilitated by the addition of an attachment tab. An attachment tab is an indentation between the outer terminus of the hairspring and the wafer from which it was etched, where the hairspring may be detached from the wafer. When hairsprings are etched from a wafer, leaving tabs which attach the end of each hairspring to the wafer confers several benefits. First, since the hairsprings remain attached to the wafer, further processing steps can be conducted on an entire wafer simultaneously instead of making it necessary to handle each spring individually. Secondly the tabs become a convenient place to apply pressure with tweezers, or similar instruments, to remove the hairspring from the wafer. Using this detachment tab aids in minimizing any accidental damage to the hairspring coils while detaching from a wafer.

Another important consideration in the design of a hairspring is the geometry of the cross-section of the coil. Traditional extrusion methods used to form the hairspring cannot be used to precisely extrude a spring with a non-rectangular cross-section. Consequently most traditional hairsprings only have square or rectangular cross sections. Nanofabrication, however, allows for the fabrication of hairsprings with different cross sections and edges.

In this patent we refer to the axis about which the hairspring oscillates as the z-axis, then the cross section can be described as the appearance of a coil of the hairspring when cut along the x/z or y/z plane.

Traditional hairsprings exhibit rectangular cross sections in the x/z or y/z planes, and thus they look the same from the top of the spiral and the bottom. Here we teach the use of non-rectangular cross sections, such as trapezoidal or ellipsoidal. We further teach a non-rectangular where the top surface is different from the bottom surface, allows the watchmaker to easily distinguish one side of the hairspring from the other. A rounded non-rectangular shape can be used to strengthen hairspring, as sharp edges can be removed or minimized, such as with a circular or ellipsoidal cross section.

In another preferred embodiment, the cross-section of the hairspring could have one or more chamfered edges. Chamfered edges have benefits of the aforementioned non-rectangular cross sections. In addition, the chamfered edge can be used as an aesthetic addition to the hairspring, reflecting light in interesting ways as the spring expands and contracts with the balance oscillations.

Another crucial advantage offered by the nanofabrication process is the ability to precisely define the geometry of the hairspring coils. The typical geometry for the coils is the Archimedes spiral. Since the hairspring is attached at one end to the balance staff and at the other end to the balance bridge, the oscillation of a hairspring whose coils are formed in the shape of an Archimedes spiral is asymmetric about the center of the spring. This asymmetry in the oscillation causes a precession of the center of mass of the spring about the center of the balance staff. This precession causes the hairspring to be non-isochronous.

The precise control over the geometry during the nanofabrication process can be utilized to compensate for the precession of the center of mass thereby restoring isochronism to the hairspring. One possible method of achieving this is elongating the last/outermost coil of the hairspring in one dimension that is perpendicular to the direction in which the center of mass deviates, thereby compensating for the asymmetry of the oscillation.

An alternate way to compensate for the movement of the center of mass during the oscillation of the spring is to alter the width of the hairspring coils along the direction of the hairspring wind. The change is width can be varied to precisely compensate for the deviation from isochronism introduced by the Archimedes spiral. Since traditional hairspring manufacture methods rely on extrusion to form the wire that is subsequently coiled into the hairspring, this geometry can only be made possible using nanofabrication techniques. Another preferred embodiment is to alter the height of the hairspring. A further preferred embodiment is to alter the elasticity of the hairspring which may be done by local ion implantation among other techniques.

Another geometry enabled by nanofabrication that is advantageous for restoring isochronism is the Fibonacci spiral. As discussed above, because the center of rotation of a hairspring is always dependent on the diameter of a balance staff, uneven expansion and contraction of the hairspring occurs while the balance is oscillating. To compensate for this, often a bent outer coil is utilized. Shaping the innermost coils of the hairspring like a Fibonacci spiral will also improve isochronism.

The final geometric alteration enabled by the nanofabrication process, which we teach in this patent, is the addition of small (less than 100 micrometers) text or graphics to the hairspring or other components for a mechanical watch. The same nanofabrication techniques, which were discussed above, can be utilized to form those features. The nanofabrication process allows for lithography on the order of nanometers. Using this technique, we can apply identification marks to the hairspring at sizes smaller than 100 micrometers. This is useful for anti-counterfeiting and verification of factory-original parts, as well as decorative purposes.

The sub-100 micrometer features can be printed on the hairspring or other components of a mechanical watch for identification purposes. The nanofabrication process allows for lithography on the order of nanometers. Using this technique, we can apply identification marks smaller than 100 micrometers to non-hairspring watch parts. This is useful for anti-counterfeiting and verification of factory-original parts, as well as decorative purposes.

### Detailed Description of the Embodiments

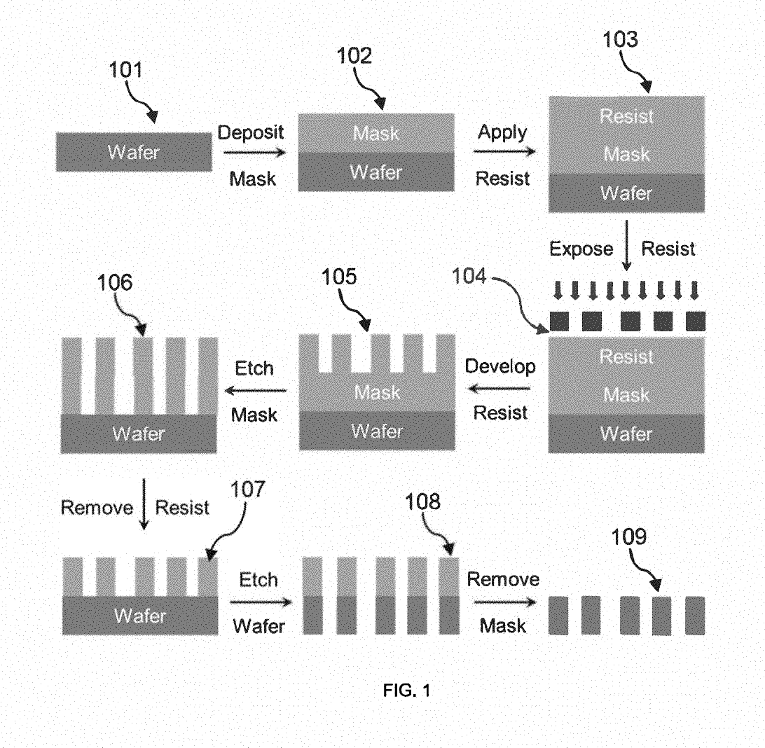

FIG. 1 is a flow chart showing depositing a masking material on top of a wafer, followed by the application of a resist material. The resist is subsequently exposed using a standard lithographic process (for example photo-lithography or electron beam lithography). Following exposure, the resist is developed, and the masking material is etched. Following the etching of the mask the resist is removed, and the wafer is etched. After etching the masking material is removed. These steps may be interchanged to achieve any desired geometry.

FIG. 1 shows the detailed steps that are needed to etch parts from a silicon wafer. The starting point is a solid wafer of any thickness or diameter 101. In the deposition stage, the wafer is covered with a layer that will become the hard mask 102. Photoresist 103 is applied as the next layer. The photoresist 103 is patterned by being exposed through an external mask 104. The photoresist is developed 105 thus leaving a pattern in the photoresist. The hard mask is etched 106 through the holes in the photoresist. The photoresist is removed, leaving just the patterned hard mask 107 on top of the wafer. The wafer is then etched through the holes in the hard mask 108. The hard mask is removed leaving just the desired components on the wafer 109.

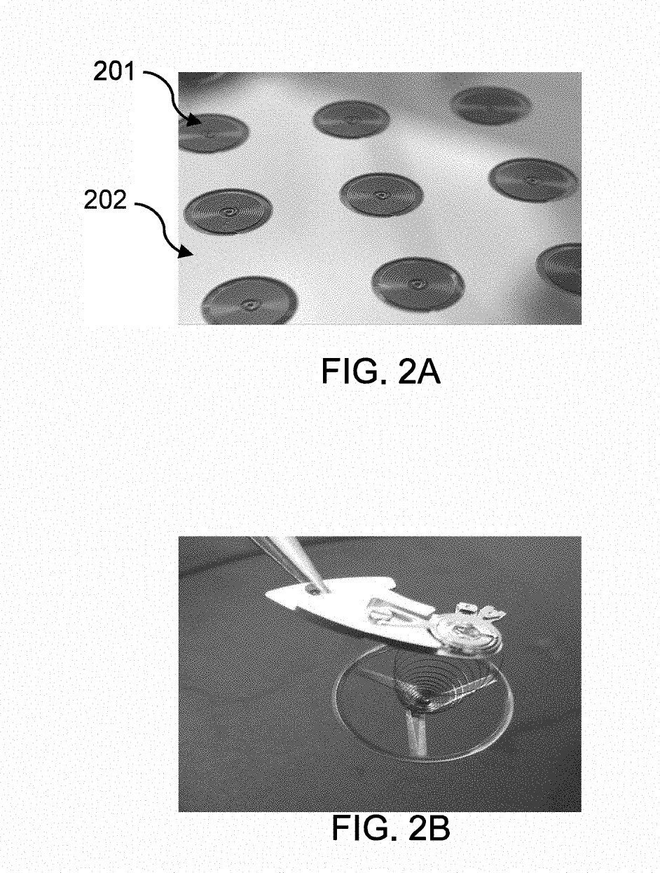

FIG. 2A shows a photograph of several hairsprings 201 connected to a wafer 202. FIG. 2B shows a photograph of a hairspring-balance assembly about to be installed into the movement of a watch.

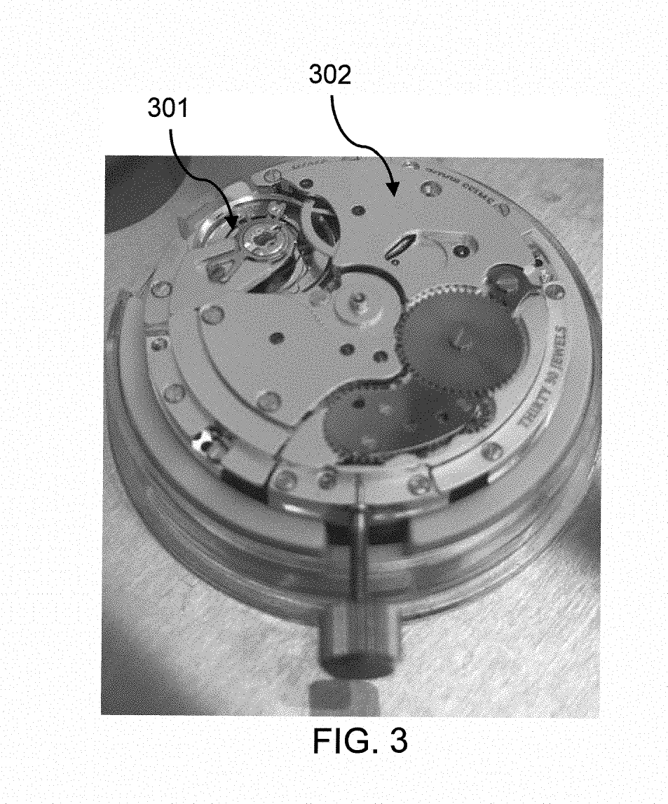

FIG. 3 shows a photograph of a mechanical watch movement. FIG. 3 shows the location of the hairspring 301 and the rest of the movement 302.

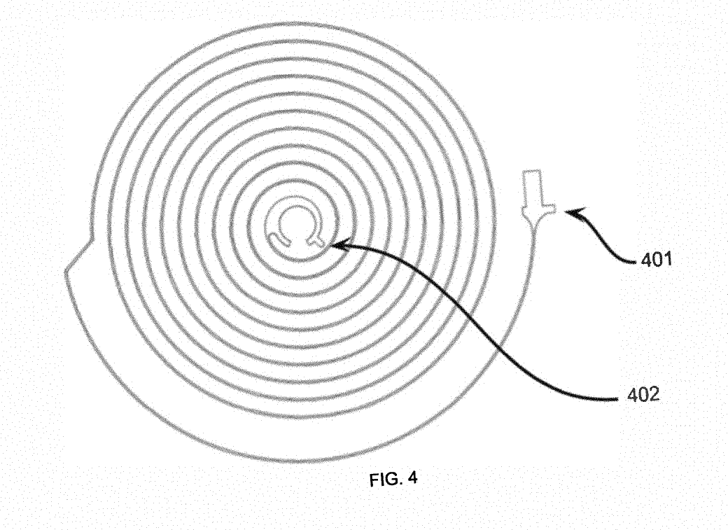

FIG. 4 shows a hairspring with a handle on outer end 401 and handle on inner end 402. The handle on the outer curve 401 or the inner curve 402 of the hairspring can be used to manipulate the hairspring during the installation or servicing of the hairspring. Utilizing the handles 401, 402 minimizes the risk of damage to the hairspring coils. The handle 401 is also useful for aligning the outer curve of the hairspring in the watch movement stud (not shown).

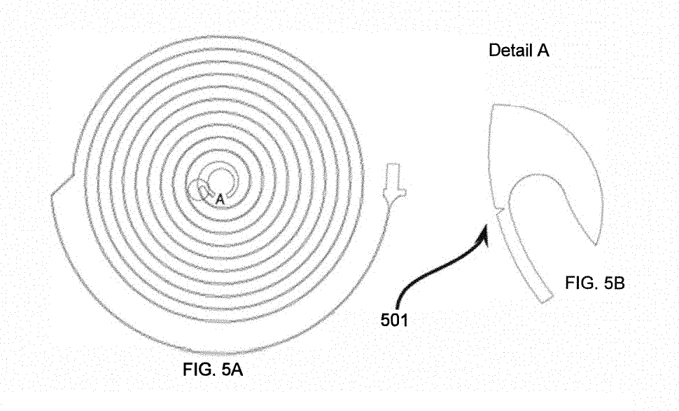

FIG. 5A shows the hairspring with a spring clip 501 as seen in Detail A. FIG. 5B shows Detail A of the hairspring, which is spring clip 501. A spring clip 501 is a detachable collet that connects the hairspring to the balance staff.

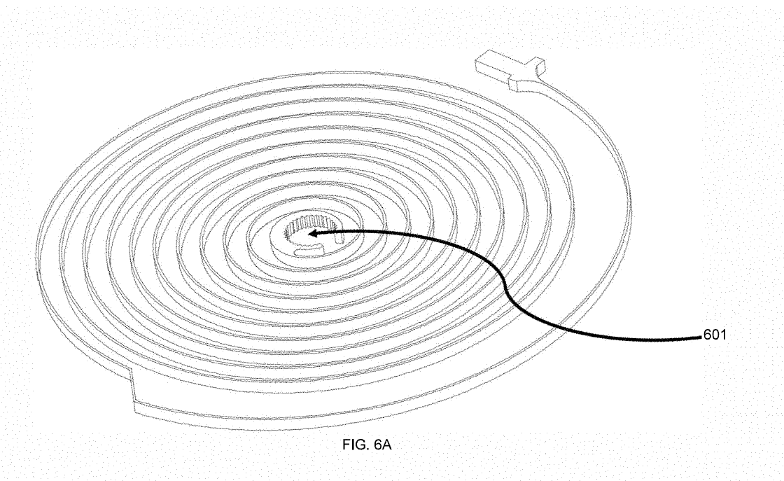

FIG. 6A shows a top perspective view of a hairspring with a collet that is both notched 601 and jagged. FIG. 6B shows a top view of a hairspring with a collet that is both notched and jagged with Detail A as seen in FIG. 6C. In FIG. 6C since the view is much more zoomed it, the jagged part of the collet is more clearly visible. The hairspring collet fits around the balance staff, which is the axis of rotation. The fit must be firm, so that it does not slip and thus affect the oscillations of the hairspring. Having a notch or opening in the collet allows the collet to be placed on a staff that is slightly larger in diameter than the collet size, thus the tension in the slightly stretched collet creates a secure friction fit.

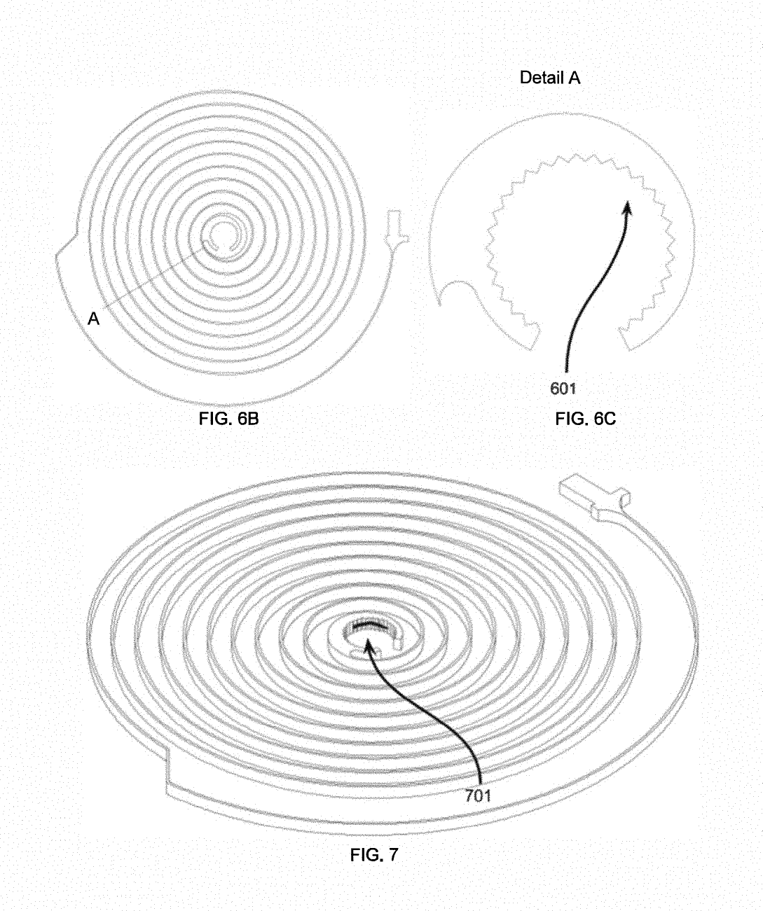

FIG. 7 shows a top perspective view of a hairspring with jagged collet plus adhesive 701. The jagged inner surface of the collet provides a convenient location for an adhesive, such as glue, to be placed all around the contact points between the collet and the balance staff. The result is a much more secure fit. In a preferred embodiment glue is used as an adhesive, but in further embodiments any adhesive that does not damage the integrity of the notch can be used to attach the collet to the balance staff.

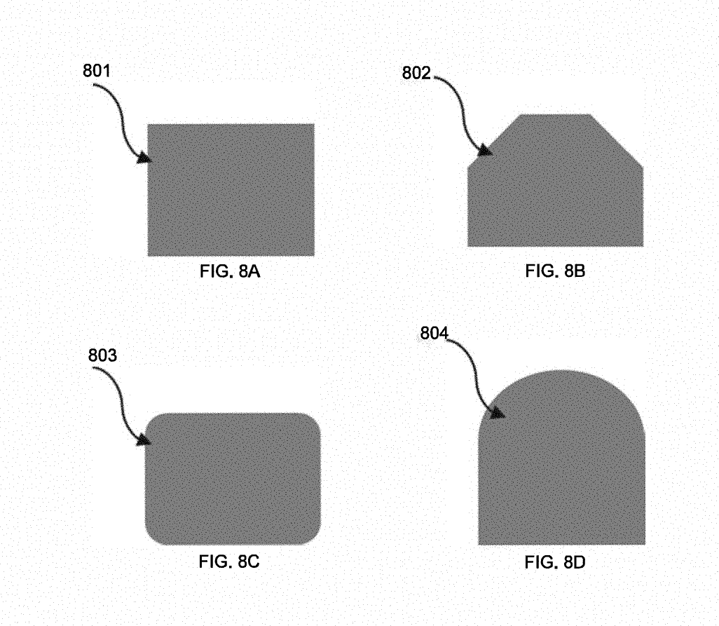

FIGS. 8A, 8B, 8C, and 8D show different cross sectional shapes of hairsprings. FIG. 8A shows a typical rectangular cross section 801. FIG. 8B shows a hairspring with two beveled edges 802. FIG. 8C shows a hairspring with four beveled edges 803. FIG. 8D shows a hairspring with one rounded side 804.

Traditional hairsprings exhibit rectangular cross sections, and thus they look the same from the top of the spiral and the bottom. A non-rectangular cross section, such one where the top surface is different from the bottom surface, allows the watchmaker to easily distinguish one side of the hairspring from the other. A non-rectangular shape can also be used to strengthen hairspring, as sharp corners can be removed or minimized, such as with a circular or ellipsoidal cross section. Furthermore the edges of the hairspring can be chamfered. Chamfered edges have benefits of the aforementioned non-rectangular cross sections. In addition, the chamfered edge can be used as an aesthetic addition to the hairspring, reflecting light in interesting ways as the spring expands and contracts with the balance oscillations.

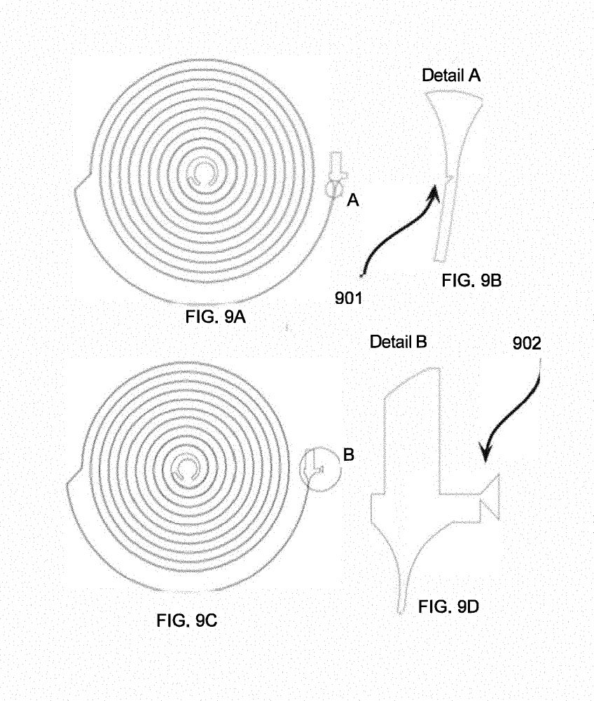

FIG. 9A shows a top view of a detachable handle on the outer terminus with Detail A. FIG. 9B shows Detail A of the detachable handle on the outer terminus, which has a convenient detachment point 901. FIG. 9C shows a top view of the outer terminus with a handle and with an attachment tab for keeping the etched hairspring attached to the wafer with Detail B. FIG. 9D shows Detail B with the attachment tab 902 and its convenient detachment point.

When hairsprings are etched from a wafer, leaving attachment tabs which connect the end of each hairspring to the wafer confers several benefits. First, since the hairsprings remain attached to the wafer, further processing steps can be conducted on an entire wafer simultaneously instead of making it necessary to handle each spring individually. Secondly the tabs become a convenient place to apply pressure with tweezers, or similar instruments, to remove the hairspring from the wafer. Using this detachment tab aids in minimizing any accidental damage to the hairspring coils while detaching from a wafer.

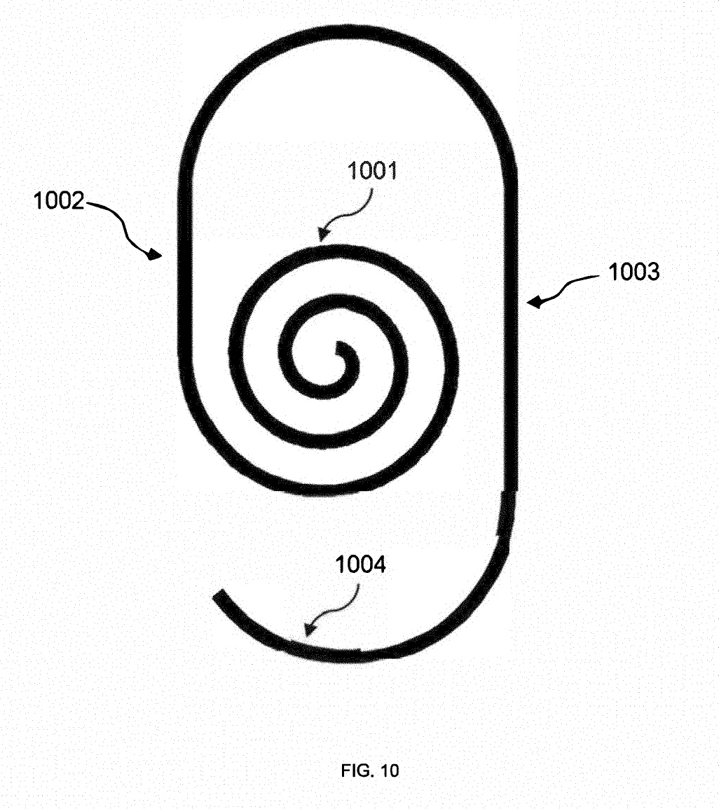

FIG. 10 shows a top view of a hairspring with elongated outermost coils. FIG. 10 shows a hairspring with a central helical section 1001, the first straight section 1002, the second straight section that is longer than the first 1003, and a final helical curved section 1004. This is done to alter the geometric moment of the hairspring in one axis and improve isochronism.

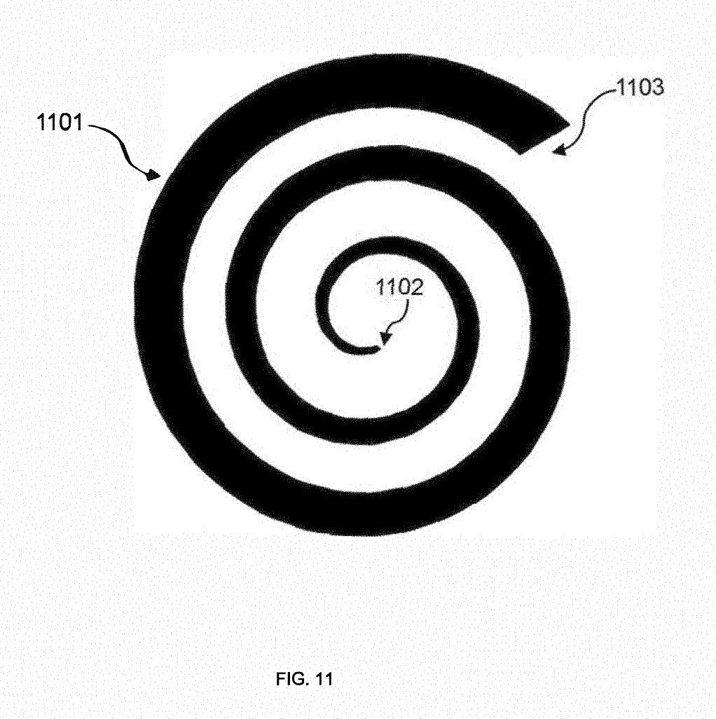

FIG. 11 shows a top view of a hairspring with a varied width. FIG. 11 shows a hairspring with a varying width 1101, an inner terminus 1102, and an outer terminus 1103. This is done to alter the geometric moment of the spring and improve isochronism.

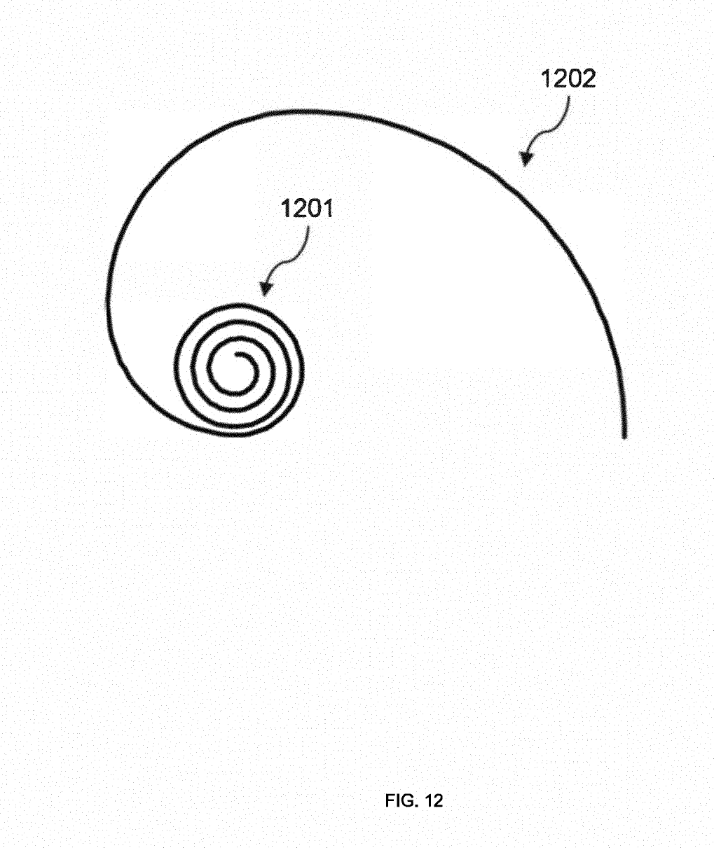

FIG. 12 shows a hairspring with an outer terminal curve. FIG. 12 shows a hairspring with a typical helical spiral in the center 1201, and an eccentric outer terminal curve 1202. Because the center of rotation of a hairspring is always dependent on the diameter of a balance staff, uneven expansion and contraction of the hairspring occurs while the balance is oscillating. To compensate for this, often a bent outer coil is utilized. With crystalline compound hairsprings, the innermost coil can also be used to compensate for isochronism. The center of mass of a hairspring ideally remains at the balance staff throughout a cycle of the oscillation for isochronism.

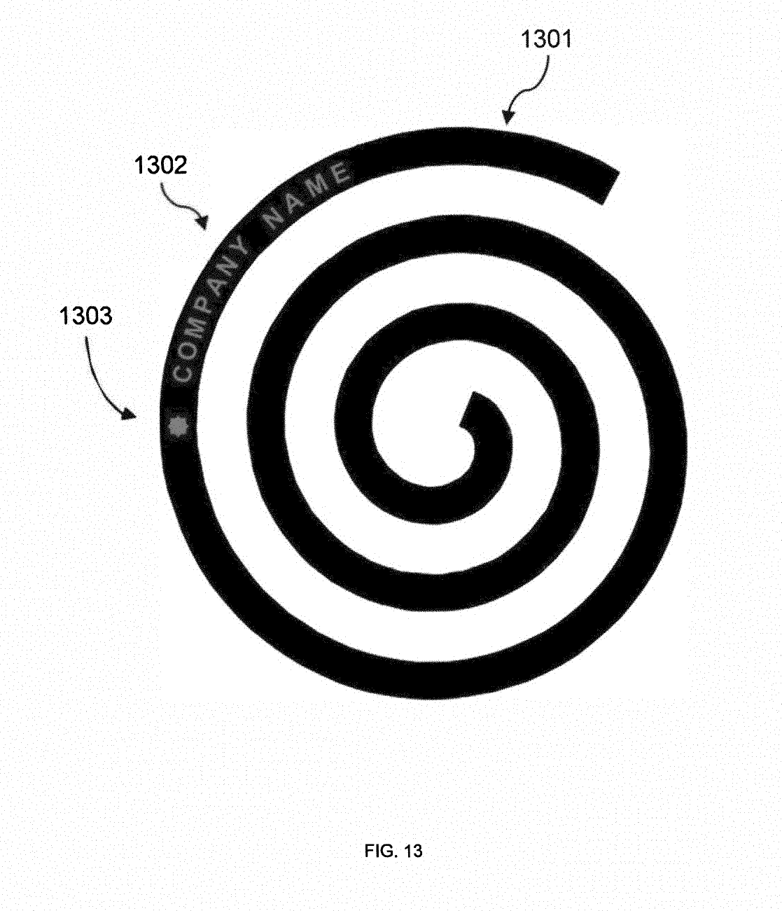

FIG. 13 shows a hairspring with an identification mark. FIG. 13 shows a hairspring 1301, with identifying words 1302, and an identifying design 1303. The text, in which the size of each letter is smaller than 100 microns can be used for identification purposes or decorative purposes. The nanofabrication process allows for lithography on the order of nanometers. Using this technique, we can apply identification marks to the hairspring at sizes smaller than 100 microns. This is useful for anti-counterfeiting and verification of factory-original parts, as well as decorative purposes.

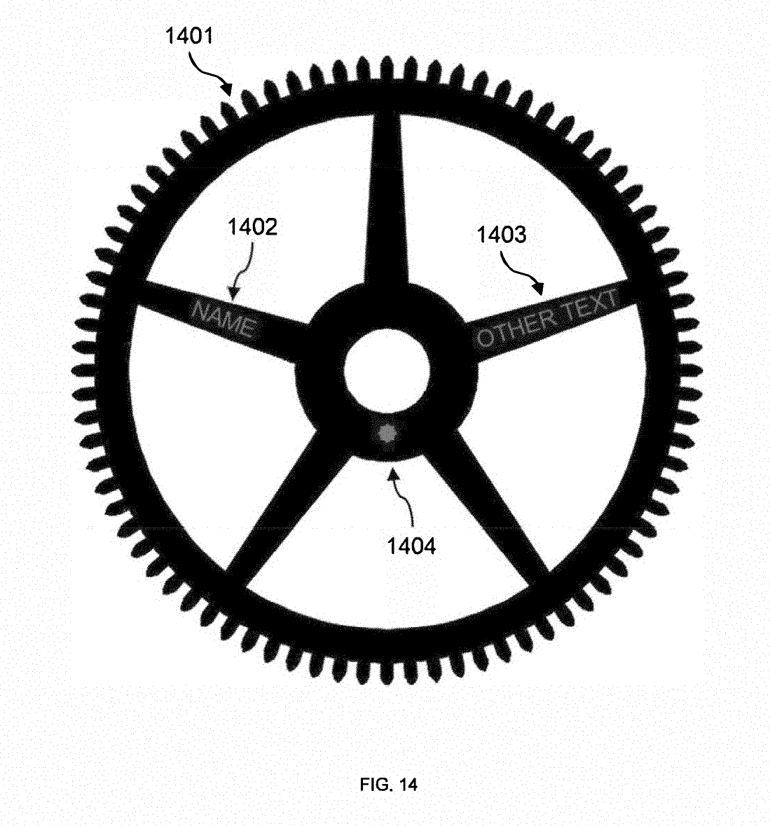

FIG. 14 shows a mechanical watch component. FIG. 14 shows a shows a mechanical watch component 1401, with an identifying name 1402, other identifying text 1403, and an identifying design 1404. The nanofabrication process allows for lithography on the order of nanometers. Using this technique, we can apply identification marks smaller than 100 microns to non-hairspring watch parts. This is useful for anti-counterfeiting and verification of factory-original parts, as well as decorative purposes.

Although only a few embodiments of the present invention have been described herein, it should be understood that the present invention might be embodied in many other specific forms without departing from the spirit or scope of the invention, including permutations of the currently described embodiments. Therefore, the present examples and embodiments are to be considered as illustrative and not restrictive, and the invention may be modified.

1. A mechanical watch comprised of a hairspring, wherein the hairspring has a plurality of coils, an inner terminus, and an outer terminus, wherein there is a component extending from the outer terminus such that a user can manipulate and adjust the hairspring during installation without touching the coils.

2. The hairspring according to claim 1, wherein there is a component on the inner terminus such that a user can manipulate and adjust the hairspring without touching the coils.

3. The hairspring according to claim 1, wherein the hairspring is made of silicon or a crystalline compound such as: gallium arsenide, extrinsically doped gallium arsenide, extrinsically doped silicon, gallium nitride, extrinsically doped gallium nitride, gallium phosphide, extrinsically doped gallium phosphide, and quartz.

4. The hairspring according to claim 1, wherein the inner terminus is a detachable spring clip.

5. The hairspring according to claim 4, wherein the inner terminus is an elastically deformable notched collet that allows the hairspring to be friction fit to a balance staff.

6. The hairspring according to claim 5, wherein the fit of the notched collet to the balance staff is further strengthened with an adhesive.

7. The hairspring according to claim 4, wherein a portion of the inner surface of the collet that connects to the balance staff is jagged.

8. The hairspring according to claim 1, the coils have a non-rectangular cross-section such as: trapezoidal, rhomboidal, hemispherical, ellipsoidal, and ovular.

9. The hairspring according to claim 1, wherein one or more of the edges of the coils are chamfered.

10. The hairspring according to claim 1, wherein the component is detachable.

11. The hairspring according to claim 1, wherein the outer terminus is connected to a wafer through a second component, wherein the hairspring can easily be detached from the wafer once processing is complete, by severing the second component from the wafer.

12. A mechanical watch comprised of a hairspring, wherein the hairspring has a plurality of circular coils, an inner terminus, an outer terminus, and the hairspring has additional coils which are ellipsoidal shaped or having additional linear sections inserted into one or several of the coils.

13. The hairspring according to claim 12, wherein the cross-section of the coil varies along the hairspring.

14. The hairspring according to claim 12, wherein the elasticity of the coil varies along the hairspring.

15. The hairspring according to claim 12, wherein the shape of at least a portion of the coils is a Fibonacci spiral.

16. The hairspring according to claim 12, wherein the hairspring is made of silicon or a crystalline compound such as: gallium arsenide, extrinsically doped gallium arsenide, extrinsically doped silicon, gallium nitride, extrinsically doped gallium nitride, gallium phosphide, extrinsically doped gallium phosphide, and quartz.

17. A mechanical watch comprised of a hairspring, with an identifying feature on the hairspring with the feature size smaller than 100 microns.

18. The mechanical watch according to claim 17, with identifying features on other mechanical watch parts.

19. The hairspring according to claim 17 with a coating on at least one facet for identification purposes.

20. The hairspring according to claim 17, wherein the hairspring is made of silicon or a crystalline compound such as: gallium arsenide, extrinsically doped gallium arsenide, extrinsically doped silicon, gallium nitride, extrinsically doped gallium nitride, gallium phosphide, extrinsically doped gallium phosphide, and quartz.
